(19) United States
(12) Patent Application Publication
(10) Pub. No.: US 2022/0275952 A1
(43) Pub. Date: Sep. 1, 2022

(54) DUCTED EVAPORATIVE AIR HUMIDIFIER

(71) Applicants: Vasilii Anatolievich KASATOCHKIN, Moscow (RU); Konstantin Borisovich SINIAGOVSKII, Moscow (RU)

(72) Inventors: Vasilii Anatolievich KASATOCHKIN, Moscow (RU); Konstantin Borisovich SINIAGOVSKII, Moscow (RU); Sergei Viktorovich NAZAROV, Moscow (RU); Nikolai Vasilievich CHEKRYSHOV, Moscow (RU)

(21) Appl. No.: 17/632,440

(22) PCT Filed: Oct. 8, 2020
(86) PCT No.: PCT/RU2020/000531

§ 371 Date: Feb. 2, 2022

(30) Foreign Application Priority Data
Aug. 8, 2019 (RU) 2019125242
Dec. 30, 2019 (CN) 201922449839.4

(51) Int. Cl. F24F 6/06

(52) U.S. Cl. CPC F24F 6/06; F24F 2006/008

(57) ABSTRACT

A ducted air humidifier includes a housing containing a water tray, a valve for supplying water to the tray, a float for controlling the water level in the tray, and an evaporator, the housing of which contains a water-absorbing and air-permeable honeycomb material, is provided with an electric drive for controllable rotation of the evaporator about the axis thereof. Furthermore, the evaporator is mounted so as to be partially and adjustably submerged in the water tray. If the honeycomb material of the humidifier is anisotropic, then in order to increase the uniformity of air humidification, several layers of honeycomb material are arranged in the housing of the evaporator, the layers of honeycomb material being offset from one another about the axis of the evaporator to increase the effectiveness of air humidification in ducted air humidifiers.

### FIELD OF DISCLOSURE

The Ducted Evaporative Air Humidifier (DEAH) belongs to the field of automation of air humidification in microclimate control systems in residential, administrative and industrial premises.

### BACKGROUND OF THE INVENTION

There is a known industrial air evaporative humidifier PRO-4000p (www.gippokrat.ru/catalog/industrial-humidifiers/industrial_humidifier_pro_4000/?r1=yandext&r2=&_openstat=bWFya2V0 LnlhbmRleC5ydTvQmtCw0L3QsNC70YzQvdGL0Lkg0YPQstC70LDQttC90LjRgtC1 0LvRjCDQstC-0LfQtNGD0YXQsC4g0J_QyNCx0L8gwqvQrdC90LXRgNCz0LjRj8K7LiDCq1BSTy 00MDAwwrs7ZGxTWFpzWEhqVzhnczhwNHB4SmdPUTs&ymclid=1564069896148 3725722200001). Inside the humidifier frame there is a tray with water and a humidifying drum, which is driven by a drive. The drum consists of multiple discs made of an easily wettable material. The discs rotate partially submerged in water. The built-in fan blows the humidifying drum perpendicular to the axis of rotation of the drum. This humidifier is not a channel duct humidifier and cannot be used in distributed air humidification systems serving several rooms at the same time. It is installed in the serviced room and maintains humidity only in this room. This industrial air humidifier PRO-4000p has the following disadvantages:
large dimensions;
large weight;
it is impossible to use this air humidifier in duct air humidifiers due to low air humidification capacity;
it is impossible to regulating the humidity of the air at the outlet of the humidifier. In the meantime, the humidity of the air is controlled only in the humidified room that is achieved by passing the air into the room through the humidifier several times.

An existing duct humidifier of evaporative type Breezart Humi (www.breezart.ru/catalog/humidifier/) that uses a water-absorbing and air-permeable honeycomb material with a large evaporating surface area (GLassPad manufactured by HuTec (hutek.com/).

The evaporating surface is 460m2 per 1m3 of material. The evaporator of the humidifier, which is a cassette with GLassPad honeycomb material, is fixedly located in the humidifier housing and is moistened with water from the sump using a circulation pump.

The humidity of the air passing through the humidifier is regulated with the help of additional air heating by an inlet preheater and an outlet afterheater.

The Breezart Humi ducted evaporative humidifier has the following disadvantages:
low reliability and maintainability due to the complexity of the design;
the need to use a drop catcher;
uncontrolled humidification of the evaporator from above using a circulation pump;
the need to use a preheater and afterheater to control air humidity;
regulation in a narrow range of humidity and air flow;
large inertia and, as a result, a long time for the humidifier to reach a given humidity;
large dimensions;
high price;
high level of noise.

### SUMMARY

### The Purpose of the Invention

The aim of the invention is to increase the efficiency of air humidification in duct humidifiers by increasing the humidity control range while expanding the range of air flow and controlled air humidification in accordance with the specified humidity parameters, as well as optimizing the air humidification process in duct humidifiers by simplifying, reducing size and cost design, elimination of preheater and afterheater, circulation pump for evaporator humidification, drift eliminator and noise reduction.

### BRIEF DESCRIPTION OF THE DRAWINGS

The accompanying drawings are presented to aid in the description of embodiments of the invention and are provided solely for illustration of the embodiments and not limitation thereof.

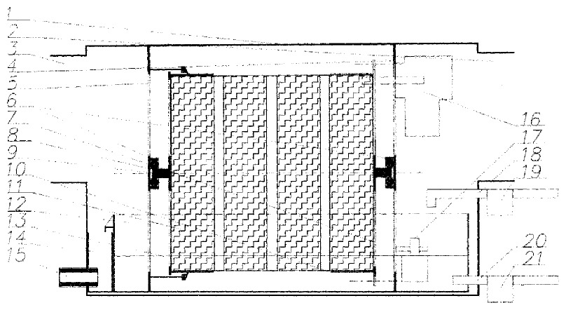

### THE FIG. 1 SHOWS A DUCT HUMIDIFIER (SECTIONAL VIEW)

1—Body
2—Inlet flange
3—Outlet flange
4—Input carrier plate
5—Output carrier plate
6—Bearings
7—Inlet cover
8—Outlet cover
9—Shaft
10—Evaporator housing
11—Honeycomb material
12—Pallet
13—Water level
14—Overflow tank
15—Overflow pipe
16—Electric drive
17—Float
18—Water supply pipe
19—Water supply valve
20—Water drain pipe
21—Water drain valve

### DETAILED DESCRIPTION

As shown in the FIGURE, the Ducted Evaporative Air Humidifier consists of body 1 with inlet 2 and outlet 3 flanges. Inside body 1 there is an inlet carrier plate 4 and an outlet carrier plate 5 with holes for air passage are located. The outer races of the bearings 6 are fixed on the plates. The inlet cover 7 and the outlet cover 8 have rigidly fixed shafts 9, which are included in the inner race of the bearings 6 and allow rotation of the evaporator body 10.

Both covers are made with holes for air passage and are tightly fitted on the evaporator body 10. The evaporator consists of the evaporator body 10 and honeycomb material 11. The evaporator body 10 is made in the form of a hollow cylinder. The honeycomb material 11 is a water-absorbing and air-permeable honeycomb material with a large evaporative surface area (GLassPad, CelPad manufactured by HuTec (hutek.com/), with an evaporative surface of 460m2 per 1m3 of material or other similar materials). If the humidifier material is anisotropic, then to increase the uniformity of humidification, it is necessary to use several layers of honeycomb material 11 with each layer turning around the axis of the evaporator body 10 relative to the adjacent layer at a certain angle (the FIGURE shows a humidifier consisting of 4 layers, each of which is rotated sequentially by an angle of 45 degrees around the axis of the evaporator body 10 relative to the previous layer in one direction.

When the evaporator rotates, the honeycomb material 11 is moistened with water poured into the tray 12 to the water level 13. branch pipe 15. The electric drive 16 rotates the evaporator through a gear of transmission.

The water level 13 in the sump 12 is controlled by the float 17. Water is added to the sump 12 through the water supply pipe 18 and is controlled by the water supply valve 19. The water is drained from the sump 12 through the drain pipe into the dy 20 and is controlled by the water drain valve 21.

Operation Principle

In the humidification mode, dry air enters through the inlet flange 2 of the housing 1 (the direction of air movement is indicated by an arrow in FIG. 1), then it passes through the holes in the inlet carrier plate 4 and the holes in the inlet cover 7 and enters the honeycomb material 11. During the rotation of the evaporator body 10, the honeycomb material 11 is moistened with water by immersing the evaporator in water in the pan 12. Dry air, passing through the honeycomb material 11 moistened with water with a large evaporating surface, is moistened, then passes through the holes in the outlet cover 8, passes through the holes in the outlet carrier plate 5 and passing through the outlet flange 3 of the body 1 is removed from the ECU. The evaporator rotates around its axis due to the gear from the electric drive 16. The inlet cover 7 and the outlet cover 8 have rigidly fixed shafts 9, which are included in the inner cages of the bearings 6 located on the input carrier plate 4 and the outlet carrier plate 5, and ensure the rotation of the evaporator around the axis of the evaporator body 10. Automatic topping up of water into the tray 12 is carried out through the water supply pipe 18 and is controlled by the water supply valve 19. The water level 13 is controlled by the float 17. The air humidity is adjusted by changing the evaporator rotation speed, alternating periods of evaporator rotation and stop, as well as a change in the water level 13 in the pan 12. When the humidity at the outlet of the Ducted Evaporative Air Humidifier is less than the lower set value, the evaporator starts to rotate. Since the evaporator is immersed in water, when the evaporator rotates, the volume of the moistened honeycomb material 11 increases, which leads to an increase in the moistened surface of the honeycomb material 11, which is blown by the air passing through the ECU. The air humidity at the outlet of the Ducted Evaporative Air Humidifier begins to increase. When the air humidity becomes higher than the upper set value, the rotation of the evaporator stops, which leads to a gradual decrease in the area of the moistened surface of the honeycomb material 11 due to the evaporation of water and, accordingly, to a decrease in air humidity at the ECU outlet. If it is necessary to significantly increase the humidity of the air passing through the ECU, in addition to the rotation of the evaporator, there is a gradual increase in the water level 13 in the pan 12 by adding water through the water supply pipe 18 when the water supply valve 19 is opened, which leads to an additional increase in the moistened surface of the honeycomb material 11 during rotation evaporator. When the required air humidity levels are reached, water refilling stops. And vice versa, if it is necessary to significantly reduce the amount of moisture evaporated by the evaporator, in addition to stopping the rotation of the evaporator, the water level 13 in the pan 12 decreases by draining the water through the water drain pipe 20 when the water drain valve 21 is opened. Water begins to overflow into the overflow tank 14 and is removed from it through the overflow pipe 15 into the sewer.

1. A ducted evaporative air humidifier, comprising a frame (body) where a tray with water is placed, a valve for supplying water to the tray, a float for controlling the level of water in the tray, an evaporator, in the frame of which there is a honeycomb material that absorbs water and allows air to pass through, wherein the ducted evaporative air humidifier is equipped with an electric drive for controlled rotation of the evaporator around the axis of the evaporator, while the evaporator is installed with partial adjustable immersion in a water pan.

2. The ducted evaporative air humidifier according to claim 1, further comprising several layers of honeycomb material that are placed in the evaporator frame, while the layers of honeycomb material are rotated relative to each other around the evaporator axis.
